(19) United States
(12) Patent Application Publication
(10) Pub. No.: US 2013/0321307 A1
(43) Pub. Date: Dec. 5, 2013

(54) HANDWRITING INPUT DEVICE

(71) Applicant: SEIKO EPSON CORPORATION, Tokyo (JP)

(72) Inventor: Maiko OBANA, Suwa (JP)

(73) Assignee: SEIKO EPSON CORPORATION, Tokyo (JP)

(21) Appl. No.: 13/898,726

(22) Filed: May 21, 2013

(30) Foreign Application Priority Data
May 29, 2012 (JP) 2012-121662

(51) Int. Cl. G06F 3/041

(52) U.S. Cl. CPC G06F 3/041
USPC 345/173

(57) ABSTRACT

The advantage of the invention is to provide a handwriting input device in which a thickness of a line can be set while confirming a thickness of a line actually drawn in a more intuitive way. In the handwriting input device in which a line is drawn in the drawing region based on a stroke of a coordinate designated by pen inputting, a circular image of a size corresponding to the thickness of the line (the number of points) set in the setting region is displayed on the drawing area, and when the setting are completed, the circular image is faded out. With this configuration, a user can set the thickness of the line while seeing the thickness of the line to be drawn in the drawing region intuitively by observing the circular image displayed on the drawing region.

### CROSS-REFERENCE TO RELATED APPLICATIONS

This application claims priority to Japanese Patent Application No. 2012-121662 filed on May 29, 2012. The entire disclosure of Japanese Patent Application No. 2012-121662 is hereby incorporated herein by reference.

### BACKGROUND

1. Technical Field

The present invention relates to a handwriting input device, having a display screen, in which settings regarding a line to be drawn are input through a setting area of the display screen, designation of an optional position in a drawing area of the display screen is input, and drawing is conducted in the drawing area using the input settings regarding a line and making the path of the input position a line.

2. Related Art

A handwriting input device in which a pen size window is provided to set a pen size (thickness of a line) has been proposed (for example, see Japanese Laid-open Patent Publication No. 2002-329212). In this device, a 0.1-millimeter scale mark is put in the upper portion of the pen size window. A mouse cursor in the pen size window is recognized, and a vertical grid line is displayed at the tip end of the cursor. When clicking with the mouse, a circular figure of a size corresponding to the thickness of the line at the tip end of the mouse cursor is displayed, and when releasing the click of the mouse, the thickness of the line is set with the size. According to the well-known device, a user can change the thickness of the line while confirming the size of the circular figure corresponding to the thickness of the line.

### SUMMARY

In the above-described device, however, the size of the circular figure corresponding to the thickness of the line is displayed on the pen size window, and actual inputting with a pen is conducted on a canvas provided in a place different from the pen size window. Therefore, some user will not be able to sufficiently image the thickness of the line to be drawn on the canvas, and there is room for improvement.

The main advantage of the invention is to provide a handwriting input device in which a thickness of a line can be set while confirming a thickness of a line actually drawn in a more intuitive way.

The handwriting input device of the invention employs the following means to achieve the above-described main advantage.

A handwriting input device of the invention, having a display screen, in which settings regarding a line to be drawn are input through a setting area of the display screen, designation of an optional position in a drawing area of the display screen is input, and drawing is conducted in the drawing area using the input settings regarding a line and making the path of the input position a line, includes a line thickness setting unit that sets a thickness of a line to be drawn in the drawing area through the setting area, and a setting confirmation display unit that temporarily displays a confirmation image of a size corresponding to the thickness of the line, set by the line thickness setting unit, on the drawing area.

In the handwriting input device of the invention, the thickness of the line to be drawn in the drawing area is set through the setting area of the display screen, and a confirmation image of a size corresponding to the set thickness of the line is displayed on the drawing area. Specifically, since a confirmation image of a size corresponding to the thickness of the line is displayed on the drawing area in which a line is actually drawn, the thickness of the line can be set while confirming the thickness of the line in a more intuitive way.

In the handwriting input device of the invention, the setting confirmation display unit can serve as a means for deleting the confirmation image after the settings regarding the thickness of the line to be drawn is completed. In this aspect of the handwriting input device of the invention, the setting confirmation display unit can serve as a means for deleting the confirmation image by gradually increasing the degree of transparency.

The handwriting input device of the invention can further include a line color setting unit that sets a color of a line to be drawn in the drawing area through the setting area. The setting confirmation display unit displays the confirmation image of a color that is substantially the same as the set color of the line on the drawing area. With this configuration, the color of the line can be confirmed in addition to the thickness of the line.

### BRIEF DESCRIPTION OF THE DRAWINGS

Referring now to the attached drawings which form a part of this original disclosure:

FIG. 1 is a schematic configuration diagram of a handwriting input device 20 according to the present embodiment;

FIG. 2 is a diagram that explains an example of a graffiti input screen;

FIG. 3 is a flow chart that shows an example of a line thickness setting process;

FIG. 4 is a diagram that explains a state of setting a thickness of a line;

FIG. 5 is a diagram that explains a state of setting a thickness of a line;

FIG. 6 is a diagram that explains a state of deleting a circular image;

FIG. 7 is a diagram that explains a state of setting a thickness of a line; and

FIG. 8 is a diagram that explains a state of setting a thickness of a line.

### DETAILED DESCRIPTION OF EXEMPLARY EMBODIMENTS

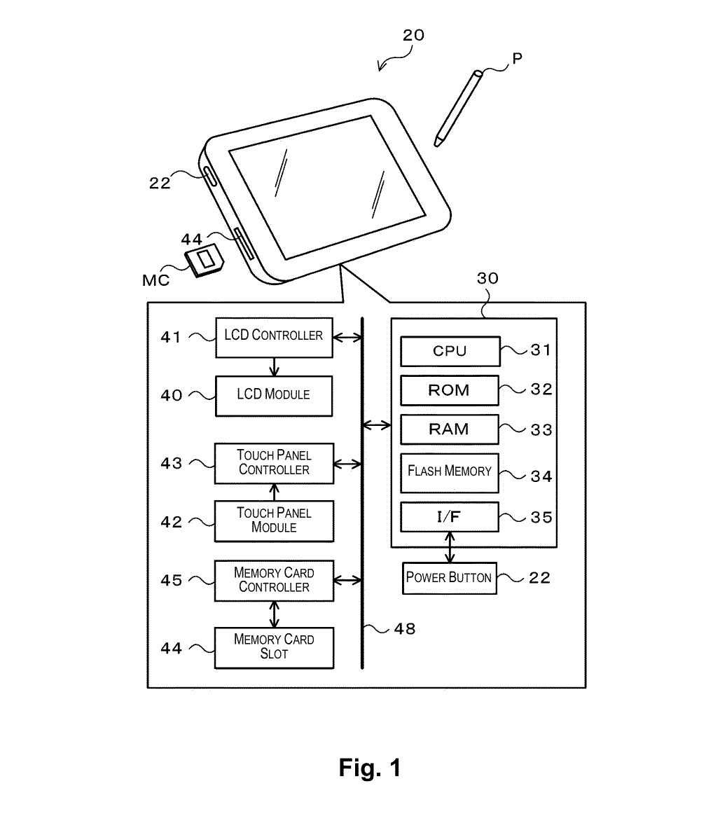

Next, embodiments of the invention will be explained with reference to the attached drawings. FIG. 1 is a configuration diagram that schematically shows the configuration of the handwriting input device 20 as an embodiment of the invention.

The handwriting input device 20 according to the present embodiment is configured as a touch panel type liquid crystal display in which an LCD module 40 for displaying a screen of various kinds of menus or sentences in process of creation and a touch panel module 42 for inputting handwritten characters or handwritten pictures with a pen P are combined. A side portion of the handwriting input device 20 has a power button 22 for starting the handwriting input device 20 and a memory card slot 44 into which a memory card MC can be inserted.

The touch panel module 42 is a coordinate input device that inputs a coordinate of a point contacted with the pen P on a touch screen. In the present embodiment, a projection type capacitance method is employed in which multipoint detection for detecting contacts with two or more points is possible. Needless to say, the method regarding the touch panel module 42 is not limited to a capacitance method, and various kinds of methods such as a resistive film method, an electromagnetic induction method, or the like can be employed. Hereinafter, a case in which handwriting input is conducted with the pen P will be explained. However, the invention includes any other embodiments in which handwriting input is possible such as an embodiment in which handwriting input is conducted with a fingertip of a person.

As shown in FIG. 1, the handwriting input device 20 has a main controller 30, an LCD controller 41, a touch panel controller 43, and a memory card controller 45 as control blocks. The main controller 30 controls the entire device. The LCD controller 41 conducts control of display to the LCD module 40. The touch panel controller 43 conducts control of input to the touch panel module 42. The memory card controller 45 conducts control of reading and writing to the memory card MC. These blocks are electrically connected with each other through a bus 48.

The main controller 30 is configured as a microprocessor centered on a CPU 31, and includes a ROM 32, a RAM 33, a flash memory 34, and an interface 35 (I/F). The ROM 32 stores various kinds of processing programs. The RAM 33 temporarily stores data. The flash memory 34 is a non-volatile memory that stores data after the power is turned off. A seizing signal from the power button 22 is input in the interface 35 (I/F). A coordinate signal or the like from the touch panel controller 43 is input in the main controller 30, and a control signal or the like to the LCD controller 41 is output from the main controller 30. Also, the main controller 30 conducts reading or writing of a file to the memory card MC through the memory card controller 45.

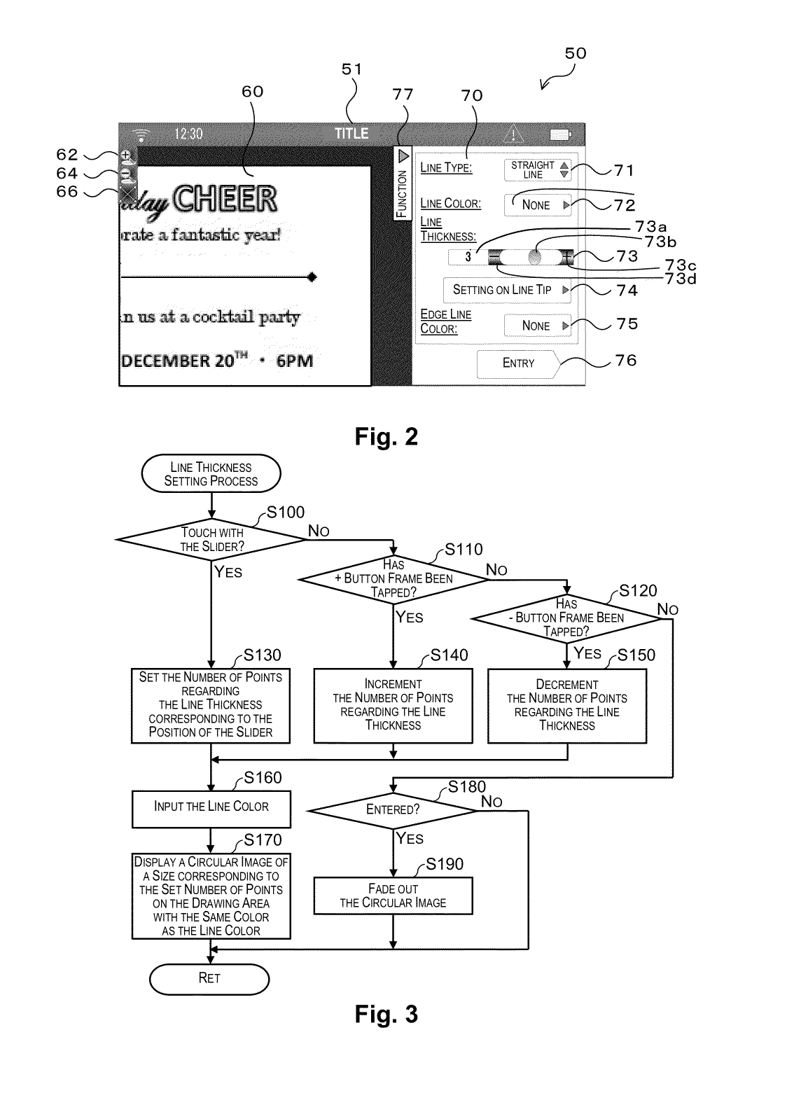

Next, explanations will be made on an operation of the handwriting input device 20 according to the present embodiment configured above. FIG. 2 is a diagram that explains an example of a graffiti input screen 50. The graffiti input screen 50 is called up when a graffiti input mode is selected from a menu screen which is not shown in the drawing. In the graffiti input mode, graffiti can be drawn with the pen P in a sentence in process of creation. A title display region 51, a drawing region 60, and a setting region 70 are displayed on the graffiti input screen 50. The title display region 51 displays the tile of the sentence in process of creation, current time, the remaining amount of a built-in battery, and the like. In the drawing region 60, a line is drawn along a pen input stroke. In the setting region 70, various kinds of settings regarding pen inputting is conducted.

On the upper left of the drawing region 60, there are provided an enlarging button frame 62 for enlarging a sentence or a figure on the display, a reducing button frame 64 for reducing a sentence or a figure on the display, and a full display button frame 66 for displaying the whole page.

The setting region 70 has a line type designating frame 71, a line color designating frame 72, a line thickness designating frame 73, a line end point designating frame 74, an edge line color designating frame 75, an entry button frame 76, a function button frame 77, and the like. The line type designating frame 71 is for designating the type of a line to be drawn such as a straight line (solid line), a dashed line, a dotted line, a broken line, or the like, for example. The line color designating frame 72 is for designating the color of a line to be drawn such as black, red, none (no color), or the like, for example. The line thickness designating frame 73 is for designating the thickness of a line to be drawn by one point in a range of 1 to 5, for example. The line end point designating frame 74 is for designating the shape of the end point of a line to be drawn such as an arrow, no end point, or the like, for example. The edge line color designating frame 75 is for designating the color of the edge of a line. The entry button frame 76 is for entering the settings in the above designating frames 71-75. The function button frame 77 is for switching display and non-display with respect to the setting region 70.

Here, the line thickness designating frame 73 has a line thickness display section 73a that displays the currently designated thickness of the line (the number of points), a slider 73b for designating the number of points regarding the thickness of the line by the sliding position, a + button frame 73c for increasing the number of points regarding the thickness of the line, and a − button frame 73d for decreasing the number of points regarding the thickness of the line. In order to designate the thickness of the line by the slider 73b, the slider 73b is touched with the tip end of the pen P, and the slider 73b is moved by sliding the pen P to the right or to the left while maintaining that state. In the present embodiment, as the slider 73b is moved to the right, the number of points regarding the thickness of the line is increased, and as the slider 73b is moved to the left, the number of points regarding the thickness of the line is decreased. Also, in order to designate the thickness of the line by the + button frame 73c, the + button frame 73c is tapped, and the thickness of the line is increased by one point with every tap. In order to designate the thickness of the line by the − button frame 73d, the − button frame 73d is tapped, and the thickness of the line is decreased by one point with every tap.

Next, explanations will be made on an operation of the handwriting input device 20 configured above, in particular, a process of setting the thickness of the line in the graffiti input mode. FIG. 3 is a flow chart that shows an example of the line thickness setting process. This routine is carried out when the setting region 70 is displayed in the graffiti input mode.

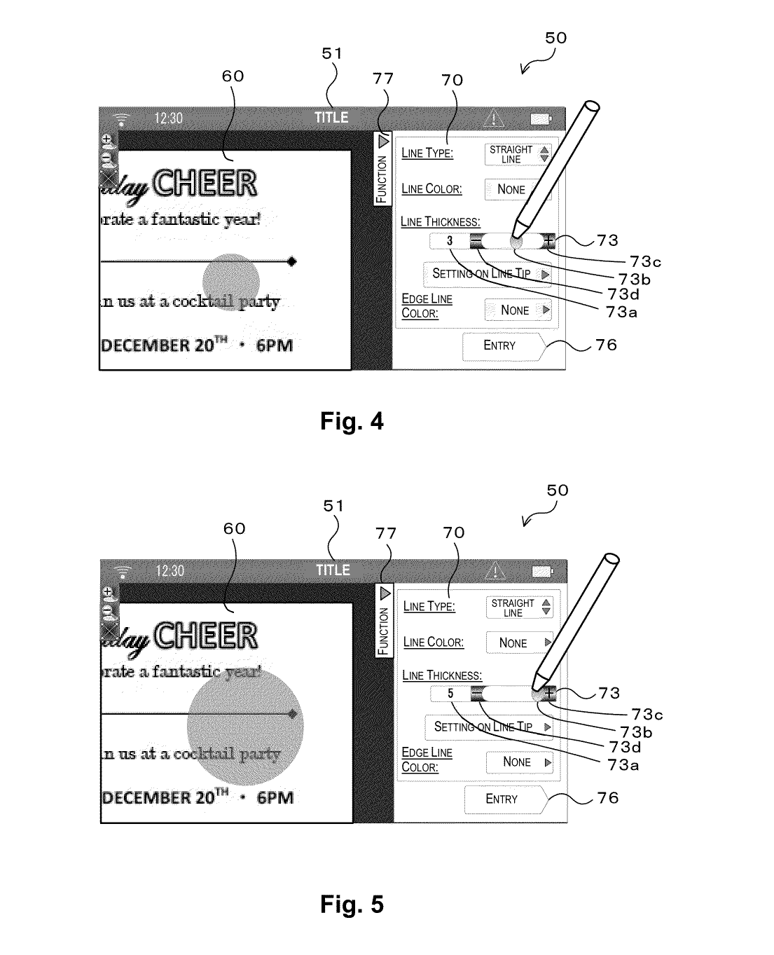

When the line thickness setting process is carried out, the CPU 31 of the main controller 30 determines whether or not the tip end of the pen P is in touch with the slider 73b (step S100), whether or not the + button frame 73c has been tapped (step S110), and whether or not the − button frame 73d has been tapped (step S120), respectively. When it is determined that the pen P is in touch with the slider 73b, the number of points regarding the thickness of the line is set corresponding to the position coordinate of the slider 73b (step S130). When it is determined that the + button frame 73c has been tapped, the current number of points regarding the thickness of the line is incremented by one point (step S140). When it is determined that the − button frame 73d has been tapped, the current number of points regarding the thickness of the line is decremented by one point (step S150). Then, the current settings regarding the color of the line are input (step S160), a circular image (confirmation image) of a size corresponding to the set number of points regarding the thickness of the line is displayed in a central position of the drawing area 60 with the same color as the input color of the line (step S170), and this process is finished. FIG. 4 and FIG. 5 are diagrams that explain a state of changing the thickness of the line using the slider 73b. As shown in the drawings, when the slider 73b is touched with the tip end of the pen P and is slid to the right or to the left, the size of the circular image is changed in accordance with the position of the slider 73b. The diameter of the circular image corresponds to the thickness of the line to be actually drawn by inputting with the pen in the drawing region 60. A user can set the thickness of the line while seeing the thickness of the line to be drawn in the drawing region 60 intuitively by observing the size of the circular image displayed on the drawing region 60.

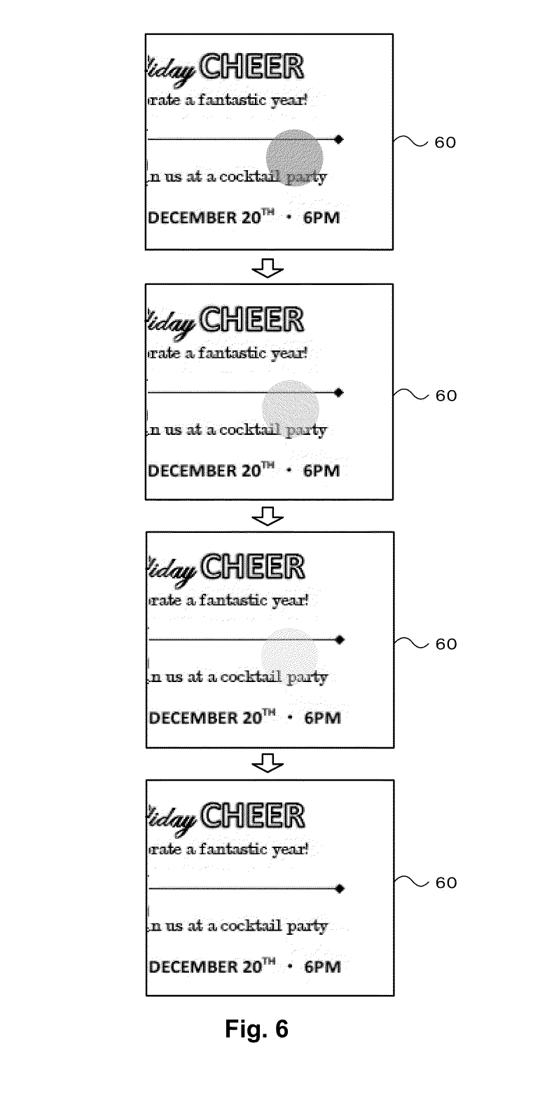

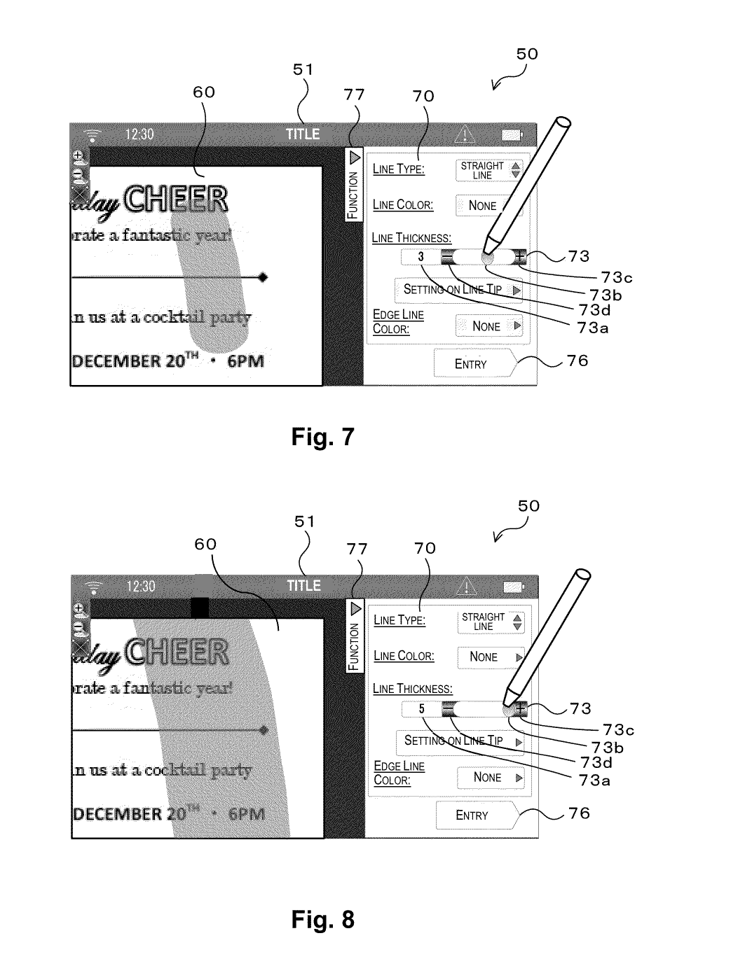

On the other hand, when it is determined that the slider 73b is not touched in step S100, when it is determined that the +button frame 73c has not been tapped in step S110, and it is determined that the − button frame 73d has not been tapped in step S120, then it is determined that the entry button frame 76 has been tapped, that is, the settings have been entered (step S180). When it is determined that the entry button frame 76 has not been tapped, this process is finished once while maintaining the display of the circular image. When it is determined that the entry button frame 76 has been tapped, the display of the circular image is deleted by fading out the display of the circular image (step S190), and then this process is finished. FIG. 6 shows a state of deleting a circular image. As shown in the drawing, a circular image is deleted by gradually increasing the degree of transparency of the image and finally making the degree of transparency 100%.

Here, the correspondence relationship between the elements of the present embodiment and the elements of the invention will be made clear. The main controller 30 that carries out the process of steps S100-S150 of the line thickness setting process shown in FIG. 3 according to the present embodiment corresponds to the “line thickness setting unit” of the invention. The main controller 30, the LCD module 40, or the LCD controller 41 that carries out the process of steps S160, S170 of the line thickness setting process corresponds to the “setting confirmation display unit”.

According to the handwriting input device 20 of the present embodiment described above, a line is drawn in the drawing region 60 based on a stroke of a coordinate designated by pen inputting. In the handwriting input device 20, a circular image of a size corresponding to the thickness of the line (the number of points) set in the setting region 70 is displayed on the drawing area 60, and when the setting are completed, the circular image is faded out. With this configuration, a user can set the thickness of the line while seeing the thickness of the line to be drawn in the drawing region 60 intuitively by observing the circular image displayed on the drawing region 60. Further, since the circular image is displayed with the same line color as the set line color, confirmation of the line color can be conducted at the same time.

In the present embodiment, the confirmation image (circular image) displayed on the drawing region 60 is faded out by gradually increasing the degree of transparency when the settings regarding the thickness of the line are completed. However, the invention is not limited to this, and for example, the confirmation image displayed on the drawing region 60 can be deleted immediately when the settings regarding the thickness of the line are completed.

In the present embodiment, a circular image is used as the confirmation image of a size corresponding to the set thickness of the line. However, the invention is not limited to this, and an image of any shape can be used as long as the size corresponds to the set thickness of the line. For example, a rectangular image or a curved line image corresponding to the set thickness of the line can be used.

In the present embodiment, the confirmation image is displayed in the central position of the drawing region 60. However, the invention is not limited to this, and the confirmation image can be displayed in any position as long as the position is in the range of the drawing region 60.

In the present embodiment, the confirmation image is displayed with the same line color as the set line color. However, the invention is not limited to this, and the confirmation image can be displayed with a fixed color (for example, gray) regardless of the set line color.

It should be noted that the invention is not limited to the above-described embodiment at all, and various embodiments are possible as long as they belong to the technical scope of the invention.

What is claimed is:

1. A handwriting input device in which designation of an optional position is input in a drawing area of a display screen, and drawing is conducted in the drawing area making the path of the input position a line, comprising:
a line thickness setting unit that sets a thickness of a line to be drawn in the drawing area; and
a setting confirmation display unit that displays a confirmation image of a size corresponding to the thickness of the line, set by the line thickness setting unit, on the drawing area.

2. The handwriting input device according to claim 1, wherein the setting confirmation display unit serves as a means for deleting the confirmation image after the settings regarding the thickness of the line to be drawn is completed.

3. The handwriting input device according to claim 2, wherein the setting confirmation display unit serves as a means for deleting the confirmation image by gradually increasing the degree of transparency.

4. The handwriting input device according to claim 1, further comprising a line color setting unit that sets a color of a line to be drawn in the drawing area, wherein the setting confirmation display unit displays the confirmation image of a color corresponding to the set color of the line on the drawing area.
